(19) United States
(12) Patent Application Publication
(10) Pub. No.: US 2006/0284807 A1
(43) Pub. Date: Dec. 21, 2006

(54) Display device, driving apparatus for the display device and integrated circuit for the display device

(75) Inventors: Kang-Yeon Cho, Suwon-si (KR); Jong-Hyuk Yoon, Hwaseong-si (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/449,507

(22) Filed: Jun. 7, 2006

(30) Foreign Application Priority Data
Jun. 16, 2005 (KR) 10-2005-0051802

(51) Int. Cl. G09G 3/36

(52) U.S. Cl. 345/89

(57) ABSTRACT

A driving apparatus and a circuit for a display device are presented. The driving apparatus includes a plurality of pixels, a positive polarity reference gray voltage generator capable of generating a plurality of positive polarity reference gray voltages, and a data driver capable of generating a plurality of negative polarity reference gray voltages based on the positive polarity reference gray voltages. The data driver is also capable of generating a plurality of positive polarity gray voltages and a plurality of negative polarity gray voltages using the positive polarity reference gray voltages and the negative polarity reference gray voltages, respectively, and applying gray voltages to the pixels. The gray voltages correspond to external image signals and are selected from the positive and negative gray voltages. The invention simplifies the design of the driving apparatus and circuitry for a display device.

### CROSS-REFERENCE TO RELATED APPLICATION

The present application claims priority from Korean Patent Application No. 2005-0051802, filed on Jun. 16, 2005, the disclosure of which is hereby incorporated herein by reference in its entirety.

### BACKGROUND OF THE INVENTION

(a) Field of the Invention

The present invention relates to a display device, a driving apparatus for the display device, and an integrated circuit.

(b) Description of Related Art

Generally, a liquid crystal display (LCD) includes two panels provided with pixel electrodes and a common electrode (referred to as “‘field generating electrodes”), and a liquid crystal (LC) layer with dielectric anisotropy interposed between the two panels. The pixel electrodes are arranged in a matrix and are connected to switching elements such as thin film transistors (TFT) through a plurality of gate lines and a plurality of data lines. The gate lines and data lines sequentially receive gate signals and data signals, respectivley. The common electrode covers the entire surface of one of the panels and is supplied with a common voltage. The pixel electrode, the common electrode, and the LC layer form an LC capacitor. The LC capacitor, together with a switching element connected thereto, forms a pixel unit.

The LCD applies voltages to the field generating electrodes to generate electric fields in the LC layer. Since light transmittance through the LC layer varies according to the strength of the electric field, desired images can be displayed by controlling the applied voltages.

Image deterioration occurs if unidirectional electric field is applied for a long time, among other causes. To prevent image deterioration, the polarity of data voltages with respect to the common voltage is reversed every frame, every row, or every pixel. The LCD includes a data driver and a reference gray voltage generator. The data driver applies data signals to the pixels through the switching elements. The reference gray voltage generator is disposed on a printed circuit board (PCB) and applies a plurality of reference gray voltages to the data driver.

For inversion driving, the reference gray voltage generator generally generates a plurality of positive-polarity reference gray voltages having larger values than the common voltage, and a plurality of negative-polarity reference gray voltages having smaller values than the common voltage. The data driver generates a plurality of gray voltages based on the reference gray and applies selected gray voltages as data signals. The selection of gray voltages is made in accordance with input image signals.

For generating the plurality of reference gray voltages, the reference gray voltage generator includes a plurality of resistors connected in series between a driving voltage and a ground voltage, to divide the driving voltage for generating the reference voltages.

Among the reference voltages, the reference voltages that are larger than the common voltage are positive polarity reference gray voltages, and the reference voltages that are smaller than the common voltage are negative polarity reference gray voltages.

Polarities of the positive polarity reference gray voltages are the reverse of those of the negative polarity reference gray voltages. Thus, the voltage differences between the common voltage and the positive polarity reference gray voltages is substantially equal to the voltage difference between the common voltage and the negative polarity reference gray voltages. The circuits that generate the positive polarity reference gray voltages are substantially similar to the circuits that generate the negative polarity reference gray voltages. Accordingly, half of the resistors are used for generating the positive polarity reference gray voltages and the other half of the resistors are used for generating the negative reference gray voltages.

The need for duplicate circuitry in the reference gray voltage generator complicates the design of the positive and negative polarity reference gray generating circuits. In particular, since a large number of resistors are required as a result of the duplication, more area is needed on the PCB for the reference gray voltage generator. This circuit redundancy heavily burdens the production of LCDs. The burden become even heavier for high image quality, which requires a range of grays and an increased number of reference gray voltages.

It is desired to make an LCD without the burden of duplicate circuitry for positive and negative reference gray voltages.

### SUMMARY OF THE INVENTION

In one aspect, the invention is a driving apparatus for a display device. The driving apparatus includes a plurality of pixels, a positive polarity reference gray voltage generator capable of generating a plurality of positive polarity reference gray voltages, and a data driver capable of generating a plurality of negative polarity reference gray voltages based on the positive polarity reference gray voltages. The data driver is also capable of generating a plurality of positive polarity gray voltages and a plurality of negative polarity gray voltages using the positive polarity reference gray voltages and the negative polarity reference gray voltages, respectively, and applying external gray voltages to the pixels. The external gray voltages correspond to image signals selected from the positive and negative gray voltages to the pixels.

In another aspect, the invention is an integrated circuit for a display device. The integrated circuit includes a first circuit element receiving a plurality of positive polarity reference gray voltages and a driving voltage, a second circuit element generating a plurality of negative polarity reference gray voltages based on the positive polarity reference gray voltages and the driving voltage, and a third circuit element generating a plurality of positive polarity gray voltages and a plurality of negative polarity gray voltages using the positive polarity reference gray voltages and the negative polarity reference gray voltages, respectively.

In yet another aspect, the invention is a display device. The display device includes a display panel having a plurality of pixels arranged in a matrix, a positive polarity reference gray voltage generator capable of generating a plurality of positive polarity reference gray voltages, and a data driver capable of generating a plurality of negative polarity reference gray voltages based on the positive polarity reference gray voltages. The data driver is also capable of generating a plurality of positive polarity gray voltages and a plurality of negative polarity gray voltages using the positive polarity reference gray voltages and the negative polarity reference gray voltages, respectively, and applying gray voltages to the pixels. The gray voltages correspond to external image signals and are selected from the positive and negative gray voltages.

### BRIEF DESCRIPTION OF THE DRAWINGS

The present invention will become more apparent by describing preferred embodiments thereof in detail with reference to the accompanying drawings in which:

FIG. 1 is a block diagram of an LCD according to an embodiment of the present invention;

FIG. 2 is an equivalent circuit diagram of a pixel of an LCD according to an embodiment of the present invention;

FIG. 3 is a block diagram of a positive polarity reference voltage generator and a data driver according to an embodiment of the present invention; and

FIG. 4 is a circuit diagram of a negative reference voltage generator according to an embodiment of the present invention.

### DETAILED DESCRIPTION OF EMBODIMENTS

The present invention will be described more fully hereinafter With reference to the accompanying drawings, in which preferred embodiments of the inventions invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items. LCDs, driving apparatuses of the LCDs, embodiments of display devices, driving apparatus of the display devices according to the present invention, and integrated circuits will be now described with reference to the drawings.

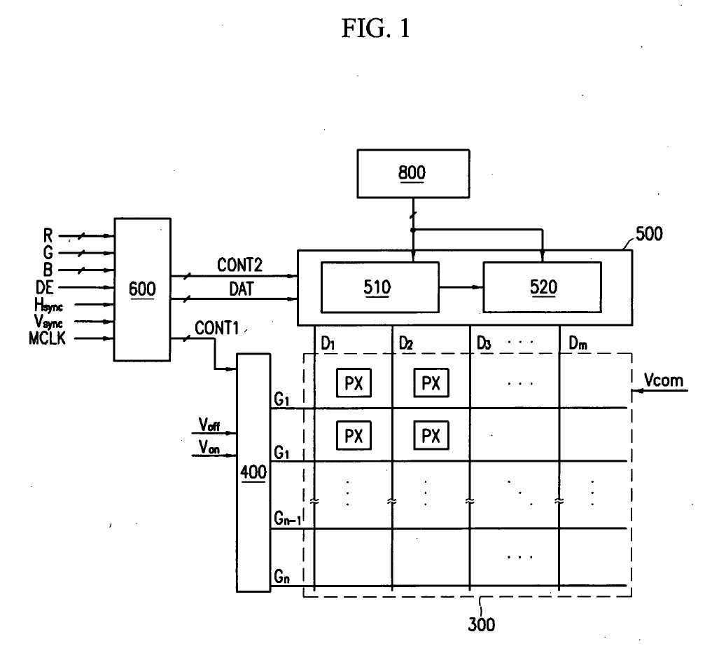

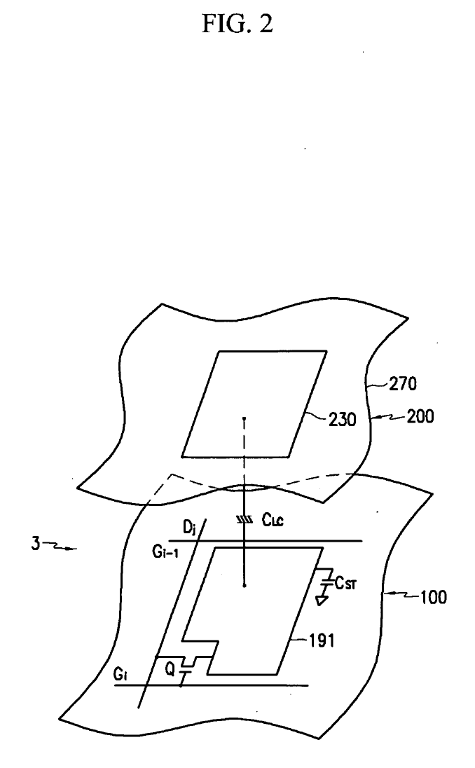

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment of the present invention includes an LC panel assembly 300 and a gate driver 400 and a data driver 500 connected to the panel assembly 300. A positive polarity reference gray voltage generator 800 is connected to the data driver 500, and a signal controller 600 sends control signals to the gate driver 400 and the data driver 500 including a negative polarity reference gray voltage generator 510 and a gray voltage generator 520.

The LC panel assembly 300, as shown in FIG. 2, includes a lower panel 100, an upper panel 200, and a liquid crystal layer 3 interposed therebetween. In addition, the LC panel assembly 300 includes a plurality of signal lines G₁-Gₙ and D₁-Dₘ and a plurality of pixels connected thereto and arranged substantially in a matrix format in a circuital view shown in FIGS. 1 and 2.

The signal lines G₁-Gₙ and D₁-Dₘ are provided on the lower panel 100, and include a plurality of gate lines G₁-Gₙ for transmitting gate signals (called scanning signals) and a plurality of data lines D₁-Dₘ for transmitting data signals. The gate lines G₁-Gₙ extend substantially in a first direction and are substantially parallel to,each other, while the data lines D₁-Dₘ extend substantially in a second direction and are substantially parallel to each other.

Each pixel includes a switching element Q connected to the display signal lines G₁-Gₙ and D₁-Dₘ, and an LC capacitor C_{LC} and a storage capacitor C_{ST} that are connected to the switching element Q. The storage capacitor C_{ST} may be omitted in some embodiments.

The switching element Q such as a TFT is provided on the lower panel 100 and has three terminals: a control terminal connected to one of the gate lines G₁-Gₙ; an input terminal connected to one of the data lines D₁-Dₘ; and an output terminal connected to the LC capacitor C_{LC} and the storage capacitor C_{ST}.

The LC capacitor C_{LC} includes a pixel electrode 191 provided on the lower panel 100 and a common electrode 270 provided on the upper panel 200 as two terminals. The LC layer 3 disposed between the two electrodes 191 and 270 functions as the dielectric material of the LC capacitor C_{LC}. The pixel electrode 191 is connected to the switching element Q. The common electrode 270 receives a common voltage Vcom and covers an entire surface of the upper panel 200. In some embodiments, the common electrode 270 may be provided on the lower panel 100, and pixel and common electrodes 191 and 270 may be shaped into bars or stripes.

The storage capacitor C_{ST} is an auxiliary capacitor for the LC capacitor C_{LC}. The storage capacitor C_{ST} includes the pixel electrode 191 and a separate signal line (not shown) that is provided on the lower panel 100. The separate signal line is positioned to overlap the pixel electrode 191 with an insulator between the pixel electrode 191 and the signal line, and receives a predetermined voltage such as the common voltage Vcom. In some embodiments, the storage capacitor C_{ST} includes the pixel electrode 191 and an adjacent gate line (“a previous gate line”) that overlaps the pixel electrode 191 with an insulator between the pixel electrode 191 and the previous gate line.

A color display can be achieved in a number of ways. One way is to designate a primary color for each pixel (i.e., spatial division) such that all the primary colors are represented by a collection of pixels, and activate select pixels to produce the desired color. Another way is to make each pixel sequentially represent different primary colors (i.e., temporal division) such that a temporal sum of the primary colors is recognized as the desired color. An example of a set of the primary colors includes red, green, and blue colors. The display of FIG. 2 employs the spatial division method in which each pixel includes a color filter 230 representing a primary color. The color filter 230 is positioned in an area of the upper panel 200 across the LC layer 3 from the pixel electrode 191. In alternative embodiments, the color filter 230 is provided on or under the pixel electrode 191 on the lower panel 100.

A pair of polarizers (not shown) for polarizing the light are attached on the outer surfaces of the panels 100 and 200 of the panel assembly 300.

Referring to FIG. 1 again, the positive polarity gray voltage generator 800 generates a set of positive polarity reference gray voltages that affect light transmittance through the pixels PX.

The gate driver 400 is connected to the gate lines G₁-Gₙ of the panel assembly 300 and synthesizes the gate-on voltage Von and the gate-off voltage Voff to generate gate signals for application to the gate lines G₁-Gₙ.

As described above, the data driver 500 includes a negative polarity reference gray voltage generator 510 and a gray voltage generator 520. The gray voltage generator 520 is connected to the positive and negative polarity reference gray voltage generators 800 and 510 and to the data lines D₁-Dₘ of the panel assembly 300.

The data driver 500 generates a set of negative polarity reference gray voltages based on the voltages from the positive polarity reference gray voltage generator 800 and divides the positive and negative polarity reference gray voltages to generate a plurality of gray voltages corresponding to all grays. The data driver 500 applies gray voltages selected from the generated gray voltages to the data lines D₁-Dₘ as data voltages. Such a data driver 500 is in detail below.

The signal controller 600 controls the gate driver 400 and the data driver 500.

Each of the driving units 400, 500, 600, and 800 is mounted on a separate PCB. However, each of the driving units 400, 500, 600, and 800 may include an integrated circuit (IC) chip mounted on the LC panel assembly 300 or on a flexible printed circuit (FPC) film in a tape carrier package (TCP) type, which is attached to the panel assembly 300. Alternatively, at least one of the processing units 400, 500, 600, and 800 may be integrated with the panel assembly 300 along with the signal lines and the switching elements Q. As yet another alternative, all the processing units 400, 500, 600, 700 and 800 may be integrated into a single IC chip, but at least one of the processing units 400, 500, 600, and 800 or at least one circuit element in at least one of the processing units 400, 500, 600, and 800 may be disposed out of the single IC chip.

Now, the operation of the LCD will be described in detail.

The signal controller 600 is supplied with input image signals R, G, and B, and input control signals for controlling the display thereof from an external graphics controller (not shown). The input image signals R, G, and B contain luminance information of each pixel PX, and the luminance has a predetermined number of, for example 1024(=2¹⁰), 256(=2⁸), or 64(=2⁶) grays. The input control signals include a vertical synchronization signal Vsync, a horizontal synchronization signal Hsync, a main clock signal MCLK, a data enable signal DE, etc.

The signal controller 600 generates gate control signals CONT1 and data control signals CONT2 and processes the image signals R, G and B suitable for the operation of the panel assembly 300 on the basis of the input control signals and the input image signals R, G and B. Then, the signal controller 600 transmits the gate control signals CONT1 to the gate driver 400 and the processed image signals DAT and the data control signals CONT2 to the data driver 500. The gate control signals CONT1 include a scanning start signal STV for instructing to start scanning, and at least one clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing the start of data transmission for a group of pixels PX, a load signal LOAD for instructing to apply the data voltages to the data lines D₁-Dₘ, and a data clock signal HCLK. The data control signal CONT2 may further include an inversion signal RVS for reversing the polarity of the data voltages (with respect to the common voltage Vcom).

In response to the data control signals CONT2 from the signal controller 600, the data driver 500 receives a packet of the digital image data DAT for the group of pixels PX from the signal controller 600, and generates the negative polarity reference gray voltages using the positive polarity reference gray voltage from the positive polarity reference gray voltage generator 800. In addition, the data driver 500 divides the positive and negative polarity reference gray voltages to generate a plurality of gray voltages, converts the image data DAT into analog data voltages selected from the generated gray voltages, and applies the data voltages to the data lines D₁-Dₘ.

The gate driver 400 applies the gate-on voltage Von to the gate line G₁-Gₙ in response to the gate control signals CONT1 from the signal controller 600, thereby turning on the switching elements Q connected thereto. The data voltages applied to the data lines D₁-Dₘ are supplied to the pixels through the activated switching elements Q.

The difference between the data voltage and the common voltage Vcom is represented as a voltage across the LC capacitor C_{LC}, which is referred to as a pixel voltage. The LC molecules in the LC capacitor C_{LC} have different orientations depending on the magnitude of the pixel voltage, and the molecular orientations determine the polarization of light passing through the LC layer 3. The polarizer(s) translates the light polarization into the light transmittance.

By repeating this procedure by a unit of a horizontal period, all gate lines G₁-Gₙ are sequentially supplied with the gate-on voltage Von during a frame. This way, the data voltages are applied to all pixels. A horizontal period (1H) is equal to one period of the horizontal synchronization signal Hsync or the data enable signal DE.

After one frame finishes, the next frame starts. When the next frame starts, the inversion control signal RVS applied to the data driver 500 is controlled such that the polarity of the data voltages is reversed (which is referred to as “frame inversion”). The inversion control signal RVS may be also controlled such that the polarity of the image data signals flowing in a data line are periodically reversed during one frame (for example, row inversion and dot inversion), or the polarity of the image data signals in one packet are reversed (for example, column inversion and dot inversion).

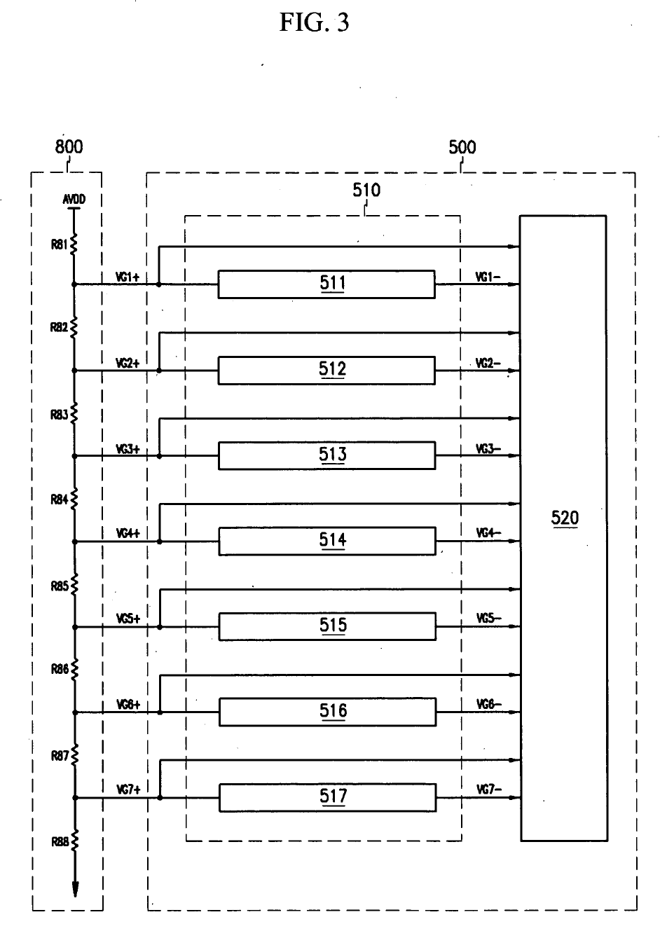

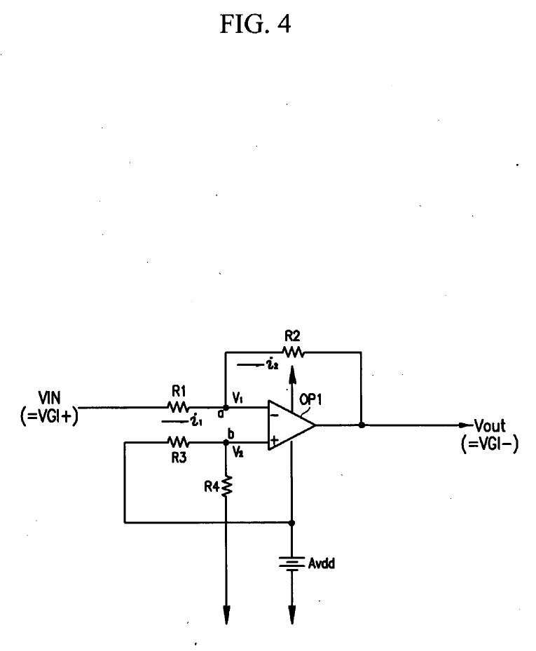

Next, the positive polarity reference gray voltage generator 800 and the data driver 500 according to an embodiment of the present invention will be described in detail with reference to FIGS. 3 and 4.

FIG. 3 is a block diagram of a positive polarity reference voltage generator and a data driver according to an embodiment of the present invention. FIG. 4 is a circuit diagram of a negative reference voltage generator according to an embodiment of the present invention.

As shown in FIG. 3, the positive polarity reference gray voltage generator 800 includes a plurality of resistors R81-R88 connected in series between a driving voltage AVDD and a ground voltage.

As described above, the data driver 500 includes the negative polarity reference gray voltage generator 510 connected to the positive polarity reference gray voltage generator 800 and the gray voltage generator 520 connected to the negative polarity reference gray voltage generator 510.

The negative polarity reference gray voltage generator 510 includes a plurality of negative polarity reference gray voltage generating circuits 511-517.

The constructions of the negative polarity reference gray voltage generating circuits 511-517 are substantially the same. Thus, to avoid repeating the same description, only the construction and the operations of the negative polarity reference gray voltage generating circuit 511 will be described with reference to FIG. 4.

Referring to FIG. 4, the negative polarity reference gray voltage generating circuit 511 includes a plurality of resistors R1-R4 and an operating amplifier OP1.

The operating amplifier OP1 includes an inverting terminal −, a non-inverting terminal +, and an output terminal.

The resistor R1 is supplied with an input voltage Vin, which is a lowest reference gray voltage VG1+ applied from the positive polarity reference gray voltage generator 800 and connected to the inverting terminal − of the operating amplifier OP1.

The resistor R2 is connected between the inverting terminal − and the output terminal of the operating amplifier OP1.

The resistor R3 is connected between the non-inverting terminal + of the operating amplifier OP1 and the driving voltage AVDD.

The resistor R4 is connected between the non-inverting terminal + of the operating amplifier OP1 and a ground voltage.

The resistance values of the resistors R1-R4 are substantially equal to each other.

At this time, the operating amplifier OP1 may be a super-abundant amplifier already designed into the data driver 500.

The gray voltage generator 520 is connected to the positive polarity reference gray voltage generator 800 and the negative polarity reference gray voltage generating circuits 511-517, and may include a plurality of resistors functioning as dividing resistors.

The operations of the positive polarity reference gray voltage generator 800 and the data driver 500 will be described below.

When the driving voltage AVDD is applied to the positive polarity reference gray voltage generator 800, the positive polarity reference gray voltage generator 800 divides the driving voltage AVDD using the resistors R81-R88 to generate a plurality of positive polarity reference gray voltages VG1+ to VG7+ and applies them to the negative polarity reference gray voltage generator 510 of the data driver 500. At this time, the positive polarity reference gray voltages VG1+ to VG7+ each have magnitudes between the driving voltage AVDD and the ground voltage.

The positive polarity reference gray voltage VG1+ of the voltages VG1+ to VG7+ is applied to the negative polarity reference gray voltage generating circuit 511 of the negative polarity reference gray voltage generator 510.

The negative polarity reference gray voltage generating circuit 511 functions as a subtractor, and subtracts the applied reference gray voltage VG1+ from the driving voltage AVDD to generate the subtracted voltage as an output voltage Vout. The output voltage Vout is a negative polarity reference gray voltage VG−.

The output voltage Vout that is outputted from the negative polarity reference gray voltage generating circuit 511 is calculated as below.

In FIG. 4, i₁ is a current applied to a node “a,” i₂ is a current outputted from the node “a”, and V1 and V2 are voltages at the node “a” and the node “b”, respectively. In addition, each of the R1 and R2 and resistance values thereof are denoted as the same reference characters.

i₁ and i₂ are obtained through Equation 1 and Equation 2.

$$\begin{matrix}{i}_{1} = \frac{( Vin - V 1 )}{R 1} & [ Equation 1 ] \\ {i}_{2} = \frac{( V 1 - Vout )}{R 2} & [ Equation 2 ]\end{matrix}$$

In accordance with Kirchhoff's Law, i₁=i₂, and thereby Equation 1 and Equation 2 are restated as Equation 3.

$$\frac{( Vin - V 1 )}{R 1} = \frac{( V 1 - Vout )}{R 2} \qquad [ Equation 3 ]$$

As described above, since the resistance values of R1 and R2 are equal to each other, Equation 3 is simplified as Equation 4.
Vout=2V1−Vin [Equation 4]

In FIG. 4, since the voltage V2 at the node “b” is calculated based on the Equation 5, and V1=V2, Equation 6 is obtained by substituting the V1 obtained through Equation 4 for V2 obtained through Equation 5.

$$\begin{matrix}V 2 = \frac{R 4}{R 3 + R 4} AVDD & [ Equation 5 ] \\ Vout = 2 \times \frac{R 4}{R 3 + R 4} AVDD - Vin & [ Equation 6 ]\end{matrix}$$

Since resistance values of the resistor R3 and R4 are the same as each other, the output voltage Vout of the operating amplifier OP1 is calculated as Equation 7.
Vout=AVDD−Vin [Equation 7]

As already described, the polarities of any reference gray voltages V+, V− having values between the driving voltage AVDD and the ground voltage, 0V, are defined by using the common voltage as the reference voltage. That is, a reference gray voltage that is larger than the common voltage is to be a positive polarity reference gray voltage V+, while a reference gray voltage that is smaller than the common voltage is to be a negative polarity reference gray voltage V−. The difference between reference gray voltages V+ and the common voltage Vcom is substantially equal to the difference between reference gray voltages V− and the common voltage Vcom. The reference gray voltages V+ and V− have equal levels but opposite polarities.

The relationship of the common voltage Vcom and the reference gray voltages V+ and V− is represented as below.

$$Vcom = \frac{V ++ V -}{2} ,$$

and then
V−=2Vcom−V+.

Since the ground voltage is 0V, 2Vcom=AVDD. As a result, the negative polarity reference gray voltage V− is V−=AVDD−V+.

Accordingly, in Equation 7 the input voltage Vin is the positive polarity gray voltage VG1+, and the output voltage Vout from the operating amplifier OP1 becomes a negative polarity reference gray voltage VG1− that corresponds to the positive polarity reference gray voltage VG1+.

Through the above operations, the negative polarity reference gray voltage generating circuits 511-517 generate negative polarity reference gray voltages VG1− to VG7− corresponding to the positive polarity reference gray voltage VG1+ to VG7+, respectively.

In one embodiment, there are seven positive polarity reference gray voltages and seven negative polarity reference gray voltages. However, the number of positive and negative polarity reference gray voltages are varied as necessary. The number of the negative polarity reference gray voltage generating circuits is determined based on the number of the positive polarity reference gray voltages.

Since the negative polarity reference gray voltage generating circuits 511-517 generate the negative polarity reference gray voltage VG1− to VG7− corresponding to the inputted positive polarity reference gray voltages VG1+ to VG7+, the gray voltage generator 520 divides the positive polarity reference gray voltages VG1+ to VG7+ and the negative polarity reference gray voltages VG1− to VG7− to generate the defined number of positive polarity gray voltages and negative polarity gray voltages, respectively. The number of positive polarity gray voltages and the number of negative polarity gray voltages vary based on the number of resistors in the gray voltage generator 520.

Through the above operations, the data driver 500 generates the negative polarity reference gray voltages using the positive polarity reference gray voltages.

According to the present invention, there is no need to design a separate circuit portion for generating the negative polarity reference gray voltages on a PCB. Thus, the number of resistors on the PCB may be reduced by half to decrease the size of the positive polarity reference gray voltage generator. The overall result of using the invention is reduced design redundancy of the PCB.

Since it is not necessary to apply the negative polarity reference gray voltages to the data driver in the present invention, the number of signals applied to the data driver is reduced by the number of negative polarity reference gray voltages. Therefore, the number of positive polarity reference gray voltages applied to the data driver is easily increased without being limited by the number of input pins of the data driver.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A driving apparatus comprising:
a positive polarity reference gray voltage generator capable of generating a plurality of positive polarity reference gray voltages; and
a data driver capable of generating a plurality of negative polarity reference gray voltages based on the positive polarity reference gray voltages, the data driver being capable of also generating a plurality of positive polarity gray voltages and a plurality of negative polarity gray voltages using the positive polarity reference gray voltages and the negative polarity reference gray voltages, respectively, and outputting external gray voltages, wherein the external gray voltages correspond to image signals selected from the positive and negative gray voltages.

2. The driving apparatus of claim 1, wherein the data driver comprises a plurality of negative polarity reference gray voltage generating circuits that are capable of subtracting the positive polarity reference gray voltages from an externally applied driving voltage and outputting the obtained voltages as the negative polarity reference gray voltages.

3. The driving apparatus of claim 2, wherein each of the negative polarity reference gray voltage generating circuits comprises:
a first resistor supplied with a positive polarity reference gray voltage;
an operating amplifier having an inverting terminal connected to the first resistor;
a second resistor having one terminal connected to the driving voltage and another terminal connected to a non-inverting terminal of the operating amplifier;
a third resistor connected between the second resistor and a ground voltage; and
a fourth resistor connected between the inverting terminal and an output terminal of the operating amplifier.

4. The driving apparatus of claim 3, wherein the first to fourth resistors have the substantially same resistance value.

5. The driving apparatus of claim 1, wherein the positive polarity reference gray voltage generator comprises a plurality of resistors connected in series between a driving voltage and a ground voltage.

6. An integrated circuit for a display device comprising:
a first circuit element receiving a plurality of positive polarity reference gray voltages and a driving voltage;
a second circuit element generating a plurality of negative polarity reference gray voltages based on the positive polarity reference gray voltages and the driving voltage; and
a third circuit element generating a plurality of positive polarity gray voltages and a plurality of negative polarity gray voltages using the positive polarity reference gray voltages and the negative polarity reference gray voltages, respectively.

7. The integrated circuit of claim 6 further comprising:
negative polarity reference gray voltage generators capable of subtracting the positive polarity reference gray voltages from the driving voltage and outputting the obtained voltages as the negative polarity reference gray voltages; and
a gray voltage generator capable of generating the positive polarity gray voltages and the negative polarity gray voltages by using the positive polarity reference gray voltages and the negative reference polarity gray voltages, respectively.

8. The integrated circuit of claim 7, wherein each of the negative polarity reference gray voltage generators comprises:
a first resistor receiving a positive polarity reference gray voltage;
an operating amplifier having an inverting terminal connected to the first resistor;
a second resistor having one terminal connected to the driving voltages and another terminal connected to a non-inverting terminal of the operating amplifier;
a third resistor connected between the second resistor and a ground voltage; and
a fourth resistor connected between the inverting terminal and an output terminal of the operating amplifier.

9. The driving apparatus of claim 8, wherein the first to fourth resistors have the substantially same resistance value.

10. A display device comprising:
a display panel having a plurality of pixels arranged in a matrix;
a positive polarity reference gray voltage generator capable of generating a plurality of positive polarity reference gray voltages; and
a data driver capable of generating a plurality of negative polarity reference gray voltages based on the positive polarity reference gray voltages, the data driver being capable of also generating a plurality of positive polarity gray voltages and a plurality of negative polarity gray voltages using the positive polarity reference gray voltages and the negative polarity reference gray voltages, respectively, and applying gray voltages to the pixels, wherein the gray voltages correspond to external image signals and are selected from the positive and negative gray voltages.

11. The display device of claim 10, wherein the data driver comprises:
a plurality of negative polarity reference gray voltage generating circuits that are capable of subtracting the positive polarity reference gray voltages from an externally applied driving voltage and outputting the obtained voltages as the negative polarity reference gray voltages; and
a gray voltage generator capable of generating the positive polarity gray voltages and the negative polarity gray voltages by using the positive polarity reference gray voltages and the negative reference polarity gray voltages, respectively.

12. The display device of claim 11, wherein each of the negative polarity reference gray voltage generating circuits comprises:
a first resistor supplied with a positive polarity reference gray voltage;
an operating amplifier having an inverting terminal connected to the first resistor;
a second resistor having one terminal connected to the driving voltages and another terminal connected to a non-inverting terminal of the operating amplifier;
a third resistor connected between the second resistor and a ground voltage; and
a fourth resistor connected between the inverting terminal and an output terminal of the operating amplifier.

13. The display device of claim 12, wherein the first to fourth resistors have the substantially same resistance value.
